(19) United States
(12) Patent Application Publication
(10) Pub. No.: US 2024/0375979 A1
(43) Pub. Date: Nov. 14, 2024

(54) DUAL PORT IONIZER FOR FLOWING FLUID

(71) Applicant: Asia Connection LLC, New York, NY (US)

(72) Inventors: Mitch Saccoccio, Hays, NC (US); Jonathan Bonelli, New York, NY (US)

(21) Appl. No.: 18/654,210

(22) Filed: May 3, 2024

Related U.S. Application Data
(60) Provisional application No. 63/465,071, filed on May 9, 2023.
(60) Provisional application No. 63/605,119, filed on Dec. 1, 2023.

(51) Int. Cl. C02F 1/461

(52) U.S. Cl. CPC C02F 1/4618; C02F 2201/004; C02F 2201/46125; C02F 2201/46145; C02F 2201/4615; C02F 2303/04

(57) ABSTRACT

An ionizer for use with circulating fluid in a body of water to reduce microbial presence in the flowing fluid by electrolytic ionization, and configured to be mounted upon a port into a stream of the flowing fluid.

### BACKGROUND OF THE INVENTION

The present invention relates to an ionizer for a flowing fluid system, e.g., including a fluid pump and a filter. More particularly, the present invention is directed to an improved ionizer which can be coupled to any number of inlet or outlet ports of a fluid pump in such system, to avoid drilling or cutting into existing piping of such circulating system.

It has been a long-felt need to improve removal of unwanted contaminants such as algae and bacteria from bodies of water such as lakes, reservoirs and swimming pools. One approach has been ionizing water flowing out of and then back to the body of water. Typically, a circulating flow of water is pumped out from the body of water, past ionizing electrodes which electrolytically destroy flowing contaminants, and then back to the body of water with the unwanted contaminants hopefully destroyed.

Previously, such ionizing electrodes had to be directly mounted in the pool plumbing, e.g., by drilling into or cutting the pipes, a cumbersome, unwieldy arrangement. Furthermore, any repair of such ionizing electrodes previously required cutting into the pipes in which the electrodes were mounted to remove them.

Accordingly, it is now possible to improve situating the ionizing mechanism in the circulating fluid to maximize removal of such contaminants, in facilitated manner and avoiding cumbersome arrangements and costly repair technique, further simplifying repair.

### SUMMARY OF THE INVENTION

Therefore, it is an object of the present invention to improve removal of unwanted contaminants such as algae and bacteria from flowing fluid.

It is also an object of the present invention to improve ionizing such flowing fluid to remove such contaminants.

It is another object of the present invention to improve arrangement of ionizing mechanism for flowing, circulating fluid.

It is a further object to eliminate need to cut into plumbing for flowing, circulating fluid to mount ionizing mechanism.

It is yet another object of the present invention to facilitate repairing ionizing electrodes for removing contaminants from flowing, circulating fluid.

These and other objects are explicitly attained by the present invention which is directed to an ionizer for attachment to a port into a flowing fluid system, e.g., a fluid pump or filter, and having a pair of electrodes for electrolytically ionizing fluid flowing through the system, a head in which the two electrodes are mounted, and wires situated within and extending out from the head for connecting each electrode with a controller and a current source. The ionizer head can be easily secured onto a port of the fluid system, such as a pump or filter.

The present invention is also directed to the combination of a dual port pump and ionizer, e.g., with a controller to explicitly control, inter alia, both amount of ionizer output and operational intervals of the ionizer.

### BRIEF DESCRIPTION OF THE DRAWINGS

The features of the present invention will be described in greater detail with reference to the accompanying drawings, in which:

FIG. 1 is a bottom perspective view of the ionizer in accordance with the present invention;

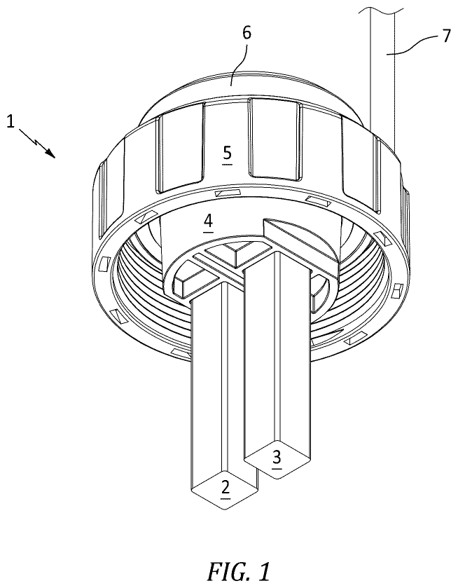

FIG. 2 is an elevational view of the ionizer attached on one port of a fluid circulation pump; and

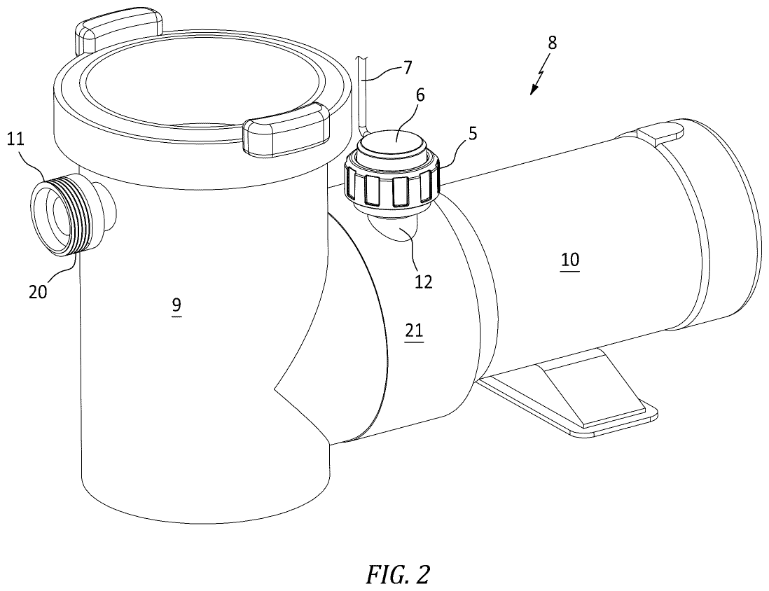

FIG. 3 is an elevational view rotated approximately 90° from FIG. 2 and illustrating the ionizer attached to another port of the circulation pump;

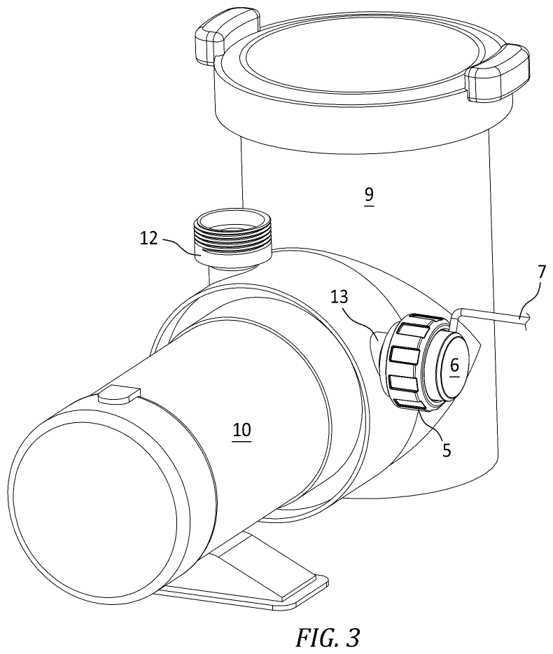

FIG. 4 is a partially exploded view of the ionizer;

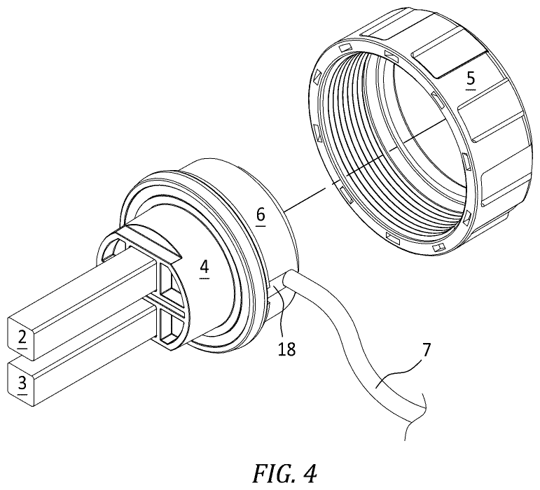

FIG. 5 is a fully exploded view of the ionizer of FIG. 4;

FIG. 6 is an elevational view similar to FIG. 3, and illustrating a controller mounted on the circulation pump and coupled to the ionizer; and

FIG. 7 is an elevational view similar to FIG. 6 and illustrating the ionizer coupled to another port of the circulation pump.

### DESCRIPTION OF PREFERRED EMBODIMENT(S)

Referring to the drawings, the dual port ionizer 1 of the present invention has a pair of electrodes 2,3 for electrolytically ionizing flowing fluid in contact therewith, and which are mounted upon a head 4. Wires 7 extend into the head 4, e.g., through a notch 14 having a curved, concave surface at a top end thereof opposite the electrodes, 2, 3, for connecting the electrodes to a system controller and a source of current for the ionizer, and which are both remote from the pump 8. The ionizer head 4 is dimensioned to securely seat on an outlet port 12 or 13 of the pump 8, and is secured thereto, by a cap 6 and bezel 5.

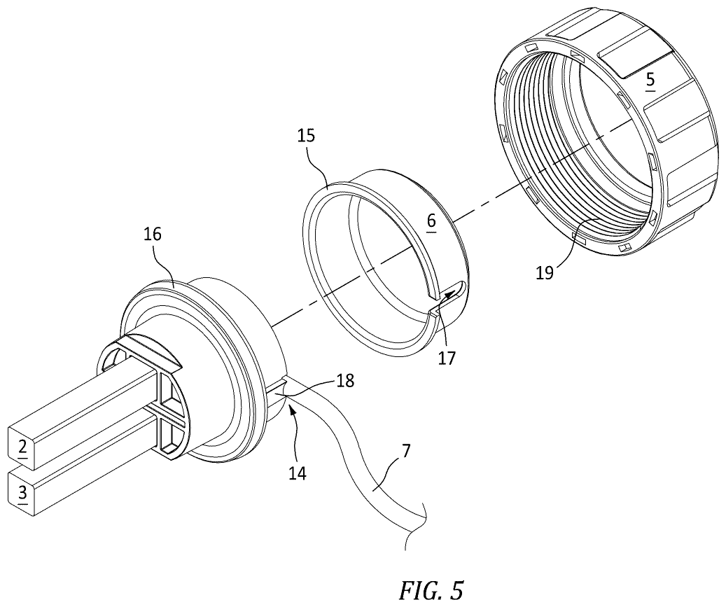

More particularly, the cap 6 seats on top of and around the head 4 of the ionizer 1, to contact the head 4 at mutual circumferential lips 15,16. The cap 6 also has an axially-extending, oblong-shaped notch 17 ending in a curved, concave bottom opposite the open end thereof. The axially-extending notch 17 in the cap 6 is arranged to mate with an axially-extending, oblong-shaped raised surface 18 along an outer cylindrical circumference of the head 4 and defining the notch 14 at the top of the head 4 as shown in FIG. 5. Thus, the wires 7 leading to the external system controller and current source from the ionizer head 4, pass through a substantially circular or oval opening defined by the mutually arranged notches 14, 17 of the head 4 and cap 6, when mated and secured together.

An annular bezel 5 secures the ionizer 1 to one of the ports 12,13 of the pump 8. More particularly, the bezel 5 is internally threaded 19 to mate with and be secured onto the one of the externally-threaded 20 ports 12 or 13, to retain the cap 6 and head 4 thereon, and with the electrodes 2,3 extending into the path of flowing fluid through the pump 8. Alternatively, the head 5 can be modified with external threads to screw into internally-threaded ports 12 or 13, to provide a one-piece ionizer 1 omitting need for a cap 6 and bezel 5.

The ionizer 1 is especially suited for coupling onto a port of a pool pump as disclosed, e.g., in U.S. Pat. No. 10,760,586, eliminating need to directly mount the ionizer within the plumbing of the pool. The control mechanism can now be feasibly arranged remotely from the pump, improving versatility. More particularly, as shown in the drawings, the pump 8, e.g., as illustrated in U.S. Pat. No. 10,760,586 (the contents of which are incorporated be reference herein), has a motor housing 10 mounted on one side of a centrifugal pump 21, with a strainer assembly 9 mounted on an opposite side of the centrifugal pump 21, and for use, e.g., above ground.

An inlet 11 for water is provided into the strainer assembly 9, while the centrifugal pump 21 has two separate tangentially-arranged outlets 12, 13 for fluid flow. Water is directed into centrifugal pump 21 from the strainer assembly 9 through a communicating axial channel (not shown) by the motor in the housing 10.

Since the centrifugal pump 21 has two outlet ports 12, 13, only one of the ports is open to cause the circulating vortex of water to exit the pump 21 therethrough. The other outlet port is capped with the ionizer 1 as described supra, so flowing water can be ionized to destroy algae, bacteria, and other contaminants in the circulating water stream. Alternatively, the ionizer 1 can be secured onto a threaded port into the filter 9.

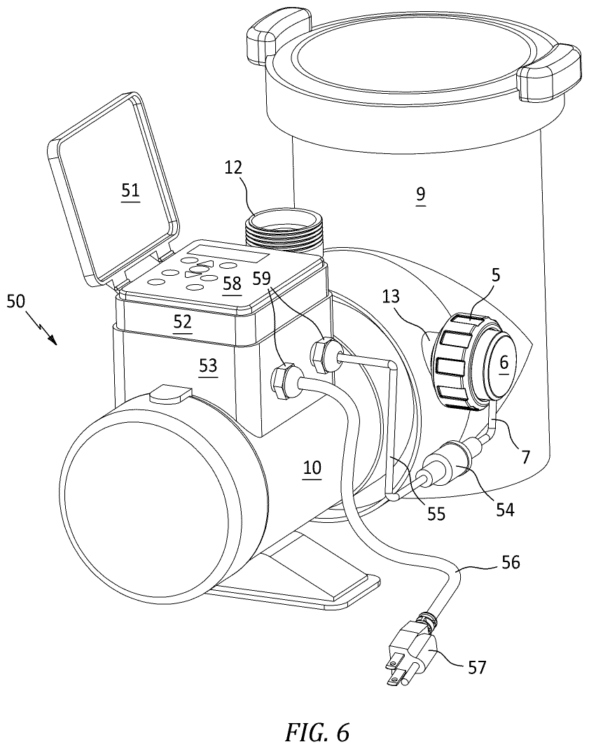

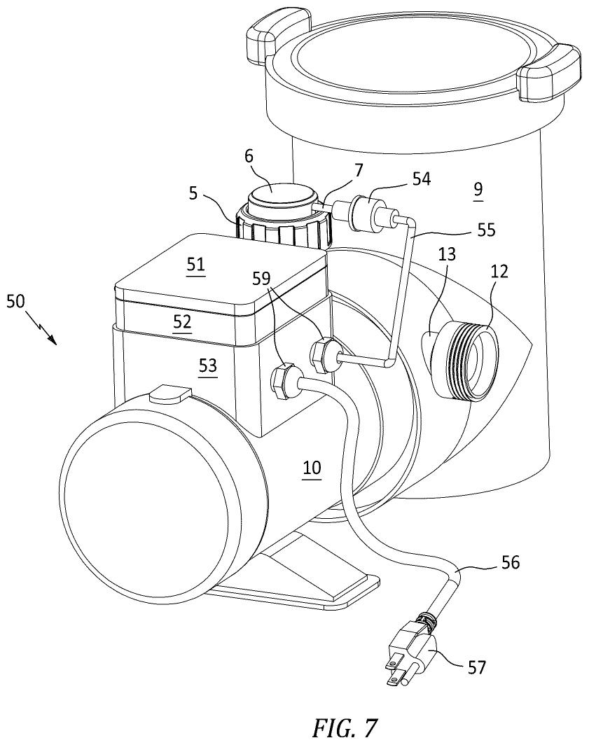

As shown in FIG. 6, the pump 8 itself can be provided with a controller 50 coupled to the ionizer 1 in turn coupled to one 13 of the outlet pumps 12, 13, while FIG. 7 shows the ionizer 1 coupled to the other outlet port 12. The controller 50 comprises a casing 52 on which a control panel 58 is situated and closed by a hinged lid 51 (as shown in FIG. 7), with the casing 52 slid into and secured to a receptacle 53 in turn mounted on the motor housing 10. The wires 7 extending from the ionizer 1 are coupled to the control casing 52 through a water proof connector 54 in turn connected to wires 55 leading into the control casing 52 through a coupler 59. Wires 56 lead out from the control casing 52 through another coupler 59 and terminate in a three-pronged plug 57 for connecting to a power source (alternatively, a twist-lock plug can be used).

The controller 50 operates the pump run time, including off and on duration and intervals, in addition to controlling ionizer 1 output, supplying power to the ionizer, and amount of such power depending upon level of contaminants and unwanted particles entrained in the flowing medium. This eliminates need for a failsafe flow switch, which is prone to failure. The ionizer 1 just needs to be changed yearly.

The electrodes 2, 3 themselves, can be formed from different metals. In this regard, the metals forming the electrodes can be versatilely combined to focus on eliminating specific contaminants. For example, copper electrodes are especially suited for eliminating algae, while silver and zinc electrodes are especially suited for eliminating bacteria, from the flowing fluid. Accordingly, combinations of copper and zinc, or copper and silver, for the respective electrodes 2,3 are preferred. For example, using copper for both electrodes will eliminate algae contaminant, while using silver or zinc for both electrodes will eliminate bacterial contaminants. Providing one electrode of copper and the other electrode of silver or zinc, will eliminate both algae and bacterial contaminants. Furthermore, each individual electrode can be formed from an amalgam of copper-silver, or copper-zinc.

The ionizer 1 itself, can be molded from hard plastic. For example, the individual head 4, cap 6 and bezel 5 can each be separately molded from plastic, with the electrodes 2,3 molded into the head 4, where the electrodes are connected the respective wires 7 leading to the current source.

The preceding description of the present invention is merely exemplary, and not intended to limit the scope thereof in any way.

What is claimed is:

1. An ionizer configured for attachment to a port into a flowing fluid system, said ionizer comprising
a pair of electrodes configured to electrolytically ionize fluid flowing through the system,
a head in which said two electrodes are mounted,
wires situated within the head and arranged to connect each electrode with a current source, the wires extending out from said head, and
means for securing said ionizer head onto the port.

2. The ionizer of claim 1, wherein said securing means comprises a cap arranged to cover and mate with a top of the ionizer head.

3. The ionizer of claim 2, wherein said cap comprises a slot allowing passage of said wires therethrough.

4. The ionizer of claim 3, wherein said means additionally comprise a bezel arranged to fit over said cap to secure said cap onto the ionizer head.

5. The ionizer of claim 4, wherein said cap comprises an outwardly flared bottom perimeter, such that an opening through said bezel is sufficiently large to fit over said cap, but said bottom perimeter of said cap is larger than said opening through said bezel.

6. The ionizer of claim 4 wherein said bezel is internally threaded to be securable to a threaded port of a pump in the system.

7. The ionizer of claim 2, wherein said means additionally comprise a bezel arranged to fit over said cap to secure said cap onto the ionizer head.

8. The ionizer of claim 7, wherein said cap comprises an outwardly flared bottom perimeter, such that an opening through said bezel is sufficiently large to fit over said cap, but said bottom perimeter of said cap is larger than said opening through said bezel.

9. The ionizer of claim 8, wherein said bezel is internally threaded to be securable to a threaded port of a pump in the system.

10. The ionizer of claim 1, wherein the current source is remotely arranged away from the system.

11. The ionizer of claim 1, wherein said two electrodes are arranged to extend through the port of the system and into a stream of fluid flowing through the system, to ionize the same.

12. The combination of a dual port pump and the ionizer of claim 1, wherein the ionizer is configured to mate with and be secured to one of the ports of the dual port pump.

13. The combination of claim 12, additionally comprising a controller for operating pump run time, on and off pumping intervals, and number of separate, individual on and off pumping intervals,
said controller also controlling ionizer output including amount of power supplied to the ionizer.

14. A method of ionizing flowing fluid to reduce presence of algae, bacteria, and other microbes in the flowing fluid, comprising the steps of
securing an ionizer to a port of a system through which fluid flows, with electrodes of the ionizer extending into a stream of flowing fluid, and
arranging a source of current for the ionizer at a location remotely away from the system.

15. The method of claim 14, wherein the ionizer is secured to the system by the steps of
mounting a head containing both said electrodes on the port,
positioning a cap onto the head,
mounting a bezel about the cap to secure the cap to the head.

16. The method of claim 15, wherein the bezel additionally secures the head and cap to the port.

17. The method of claim 16, wherein the bezel screws onto an outwardly-threaded port.
